(19) United States
(12) Patent Application Publication
(10) Pub. No.: US 2017/0064396 A1
(43) Pub. Date: Mar. 2, 2017

(54) BROADCAST RECEIVING DEVICE, METHOD FOR CONTROLLING THE SAME AND COMPUTER-READABLE RECORDING MEDIUM

(71) Applicant: SAMSUNG ELECTRONICS CO., LTD., Suwon-si (KR)

(72) Inventors: Geun-sik YUN, Yongin-si (KR); Dong-uk SEO, Cheonan-si (KR)

(73) Assignee: SAMSUNG ELECTRONICS CO., LTD., Suwon-si (KR)

(21) Appl. No.: 15/213,915

(22) Filed: Jul. 19, 2016

(30) Foreign Application Priority Data
Aug. 28, 2015 (KR) 10-2015-0121567

(51) Int. Cl. H04N 21/466; H04N 21/2668; H04N 21/482; H04N 21/45; H04N 21/442; H04N 21/81; H04N 21/234

(52) U.S. Cl. CPC H04N 21/4668; H04N 21/812; H04N 21/2668; H04N 21/23424; H04N 21/4532; H04N 21/8133; H04N 21/44213; H04N 21/4826

(57) ABSTRACT

A broadcast receiving device includes: a broadcast receiver configured to receive a digital broadcasting signal; a display configured to display images obtained by decoding the received digital broadcasting signal; and a processor configured to control the display to display a list of other channels associated with a program channel if a start of an advertisement image after a program image among the images is sensed, and display an image of a selected channel if a user selects one channel from the list of other channels.

### CROSS-REFERENCE TO RELATED APPLICATIONS

This application claims priority from Korean Patent Application No. 10-2015-0121567, filed on Aug. 28, 2015 in the Korean Intellectual Property Office, the disclosure of which is incorporated herein by reference in its entirety.

### BACKGROUND

1. Field

Apparatuses and methods consistent with exemplary embodiments relate to a broadcast receiving device providing a list of other channels associated with a channel that a user is watching if a start of an advertisement image is sensed while he or she watches the broadcast, a method for controlling the same, and a computer-readable recording medium.

2. Description of the Related Art

Due to the advancement of technologies in digital broadcasting, various types of electronic devices have supported digital broadcasting services. In addition to devices such as a digital broadcasting television (TV) and a set top box furnished inside a house or apartment, portable devices that are carried by individuals, e.g., a portable phone, a navigation device (GPS device), a PDA, an MP3 player, etc., include functions supporting the digital broadcasting services.

Further, cable or satellite broadcasting providers that perform multi-channel broadcasting frequently provide an electronic program guide (EPG) to provide convenience of channel selection to a viewer. That is, the cable or satellite broadcasting providers transmit information about corresponding broadcasting while inserting the information between broadcasting signals, and a receiving device receives a broadcasting signal and separates EPG information from the broadcasting signal to display the EPG information when a user wants to watch it.

When advertisement broadcasting starts while a user watches the digital broadcasting, the viewer has to inconveniently continuously change a channel to search for other channels that are on the air or waste time to confirm contents which are on the air on other channels by displaying the received EPG information.

Therefore, a technology for sensing when an advertisement starts while a user watches a broadcast to provide a list of a user's preference channels, or channels having a type similar to that of a channel which a user is currently watching, to thereby easily provide a broadcasting option to the user, may be useful.

### SUMMARY

Exemplary embodiments may overcome the above disadvantages and other disadvantages not described above. However, exemplary embodiments are not required to overcome the disadvantages described above, and an exemplary embodiment may not overcome any of the problems described above.

Exemplary embodiments relate to a broadcast receiving device providing a list of other channels associated with a channel that a viewer is watching when a start of an advertisement image is sensed while he or she watches broadcasting, a method for controlling the same, and a computer-readable recording medium.

According to an aspect of an exemplary embodiment, there is provided a broadcast receiving device including: a broadcast receiver configured to receive a digital broadcasting signal; a display configured to display images that are obtained by decoding the received digital broadcasting signal; and a processor configured to, in response to sensing a start of an advertisement image, control the display to display a list of other channels associated with a program channel, and in response to a user selecting a channel from among the other channels, display an image of the selected channel.

The processor may be further configured to sense the start of the advertisement image using program and system information protocol (PSIP) information included in the received digital broadcasting signal.

The broadcast receiving device may further include a memory configured to store at least one among channel information classified according to a program type and preference information previously input by the user.

The list of other channels associated with the program channel may be generated by using at least one among the channel information indicating a program having a type that is similar to the program channel and the preference information stored in the memory, and wherein the channel information indicating the program having the type similar to the program may be determined according to a frequency of the channels.

The processor may be further configured to, in response to sensing the start of the advertisement image, display the list of other channels associated with the program channel along with the advertisement image.

The processor may be further configured to, in response to sensing the start of the advertisement image, display the list of other channels associated with the program channel in the advertisement image in a picture in picture (PIP) scheme.

The processor may be further configured to display the image of the selected channel in the advertisement image in the PIP scheme in response to the user selecting one channel from the list of other channels associated with the program channel.

The processor may be further configured to, in response to the user selecting one channel from the list of other channels, change the advertisement image to the image of the selected channel and display the advertisement image in a PIP scheme.

The processor may be further configured to, in response to the start of the advertisement image being sensed, change the advertisement image to an image of another channel among the other channels that is associated with the program channel, display the list of other channels associated with the program channel in the changed image, and in response to the user selecting one channel from the list of other channels, change the changed image to the image of the selected channel.

The another channel may be one among a channel having a lowest channel number among the other channels associated with the program channel and a channel number that is closest to the program channel number.

The processor may be further configured to, in response to the start of the advertisement image being sensed and the user not selecting a channel from the list of other channels for a predetermined time, display the list of other channels associated with the program channel.

According to an aspect of another exemplary embodiment, there is provided a broadcast receiving device, including: a broadcast receiver configured to receive a digital broadcasting signal; and a processor configured to provide images that are obtained by decoding the received digital broadcasting signal to an external display device, and in response to sensing a start of an advertisement image, provide an image displaying a list of other channels associated with the program channel to the external display device, and in response to a user selecting one channel from among the list of other channels, change the advertisement image to an image of the selected channel.

According to an aspect of another exemplary embodiment, there is provided a method for controlling a broadcast receiving device, the method including: receiving a digital broadcasting signal; displaying images obtained by decoding the received digital broadcasting signal; in response to sensing a start of an advertisement image, displaying a list of other channels associated with a program channel; and in response to a user selecting a channel from among the other channels, displaying an image the selected channel.

The sensing the start of the advertisement image may include using program and system information protocol (PSIP) information included in the received digital broadcasting signal.

The method may further include storing at least one among channel information classified according to a program type and preference information previously input by the user, wherein the list of other channels associated with the program channel is generated by using at least one of the channel information having a same frequency as the program channel and the channel information classified according to the program type.

The displaying the list of other channels associated with the program channel may include, in response to sensing the start of the advertisement image, displaying the list of other channels associated with the program channel in a picture in picture (PIP) scheme.

The displaying the image of the selected channel may include, in response to the user selecting one channel from the list of other channels, displaying the image of the selected channel in the PIP scheme.

The displaying the image of the selected channel may include, in response to the user selecting one channel from the list of other channels, changing the advertisement image to the image of the selected channel and displaying the changed image in the picture in picture (PIP) scheme.

The method may further include, in response to the start of the advertisement image being sensed, changing the advertisement image to an image of another channel among the other channels associated with the program channel, wherein the displaying of the image of the selected channel may include, in response to the user selecting one channel from the list of other channels, changing the changed image to the image of the selected channel.

According to an aspect of another exemplary embodiment, there is provided a broadcast receiver including: a processor configured to: receive a digital broadcasting signal; in response to sensing a start of an advertisement image, control a display to display a list of other channels associated with a program channel; and in response to receiving a user selection selecting a channel from the list of other channels, control the display to display an image corresponding to the selected channel.

The broadcast receiver may further include a display configured to display images corresponding to the received broadcasting signal.

The processor may be further configured to display the list of other channels associated with the program channel in a sub-screen overlaying the image of the program channel.

The displaying the image corresponding to the selected channel may further include displaying the program channel in a picture in picture (PIP) scheme.

The advertisement image may be provided by at least one of a national broadcast station or a local broadcast station.

### BRIEF DESCRIPTION OF THE DRAWINGS

The above and/or other aspects will be more apparent by describing exemplary embodiments with reference to the accompanying drawings, in which:

FIG. 1 is a diagram schematically illustrating an operation of a broadcast receiving device according to an exemplary embodiment;

FIG. 2 is a block diagram illustrating a configuration of the broadcast receiving device according to an exemplary embodiment e;

FIG. 3 is a diagram schematically illustrating an example of advertisement image start information inserted while a user watches a broadcasting program;

FIGS. 4 and 5 are tables showing an example of program and system information protocol (PSIP) information for sensing the start of the advertisement image inserted while the user watches the broadcasting program;

FIG. 6 is a flow chart for describing a method for changing a channel according to an exemplary embodiment; and

FIGS. 7 to 9 are diagrams for describing an operation of a broadcast receiving device according to one or more exemplary embodiments.

### DETAILED DESCRIPTION OF EXEMPLARY EMBODIMENTS

Below, exemplary embodiments will be described in detail with reference to the accompanying drawings. In describing exemplary embodiments, detailed description of relevant known functions or components may be omitted if it would obscure the description of the subject matter. In addition, the exemplary embodiments may be changed in various forms, and therefore, the technical scope is not limited to the following exemplary embodiments. Rather, these exemplary embodiments are provided to make the present disclosure thorough and complete.

Unless explicitly described otherwise, the term ‘including’ will be understood to imply the inclusion of a component, but not the exclusion of any other components. Further, various elements and areas in the drawings are schematically drawn. Therefore, the technical ideas are not limited by a relative size or interval drawn in the accompanying drawings.

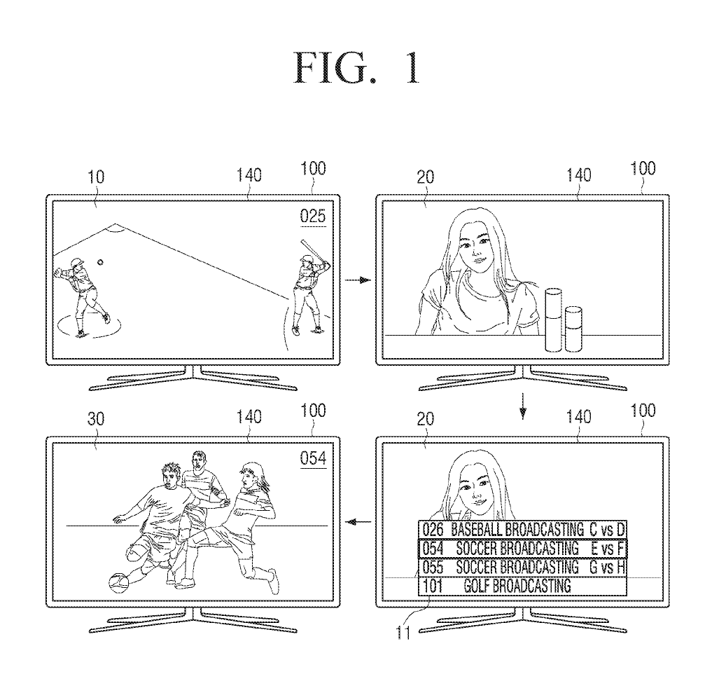

FIG. 1 is a diagram schematically illustrating an operation of a broadcast receiving device according to an exemplary embodiment.

Referring to FIG. 1, when an advertisement image starts while a user watches broadcasting, a broadcast receiving device 100 displaying a list of other channels associated with a channel that he or she is watching is disclosed. When the advertisement image starts while the user watches a broadcast, the broadcast receiving device 100 may sense the start of the advertisement image and display the list of other channels associated with the channel that the user is watching and when the user selects one channel from the list, the broadcast receiving device 100 may display the image of the selected channel.

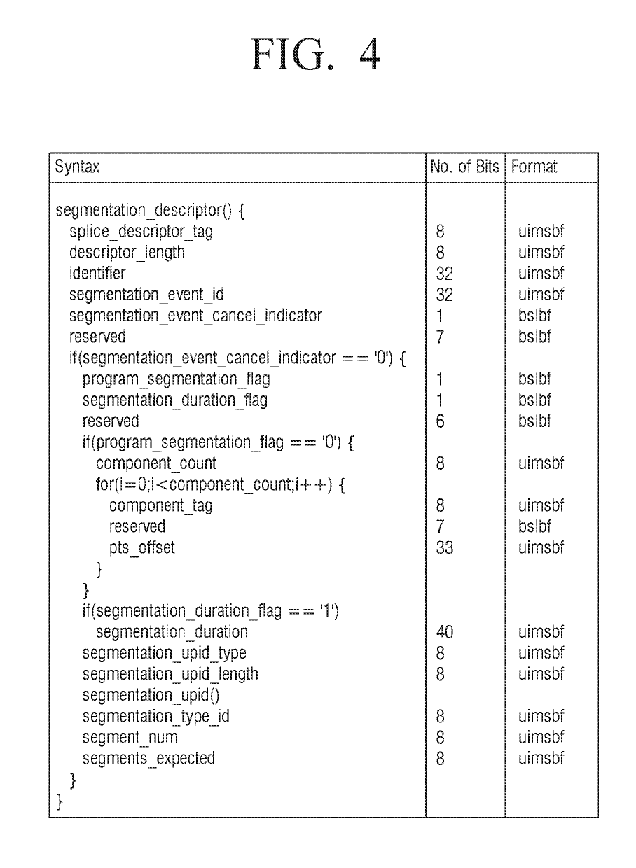

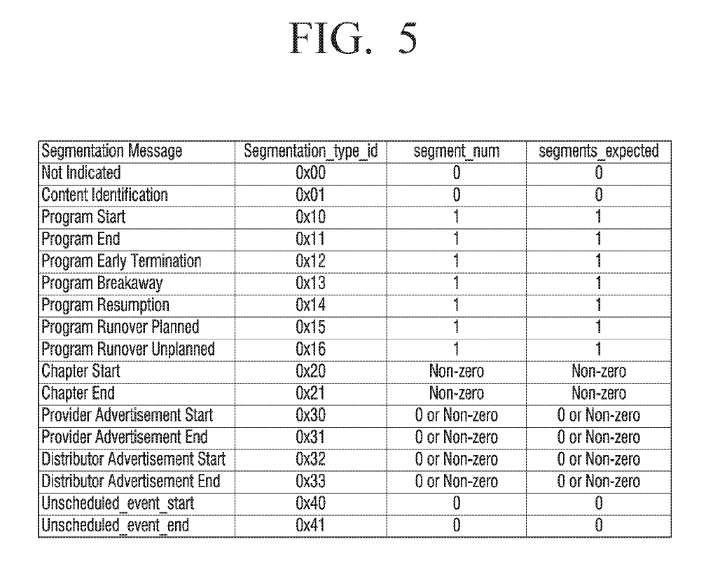

For example, when an advertisement image 20 (e.g., a cosmetics advertisement) starts at intermission time while the user watches baseball broadcasting 10 (e.g., A team vs B team) broadcast on a channel [025], the broadcast receiving device 100 may sense a start of the advertisement image 20 and display the advertisement image 20 and a list 11 of other channels associated with the baseball broadcasting channel [025] that the user is watching together. A method for sensing a start of an advertisement image will be described below with reference to FIGS. 4 and 5.

In this case, the list 11 of other channels may be a sport channel list. In detail, the list 11 of other channels may include a channel [026] on which a baseball game of another team is broadcast (for example, C team vs D team), channels [054] and [055] on which a soccer game is broadcast, and a channel [101] on which a golf game is broadcast, etc.

In this case, when the user selects a channel [054] on which the soccer game is broadcast from the list 11 of other channels displayed along with the advertisement image 20, the broadcast receiving device 100 may change the advertisement image 20 to an image 30 of the channel [054] on which the soccer game is broadcast, and display the image 30.

FIG. 1 illustrates that a single broadcast receiving device displays an image, but a plurality of broadcast receiving devices may also display the image. Below, for convenience of explanation, it will be described that the single broadcast receiving device displays the image.

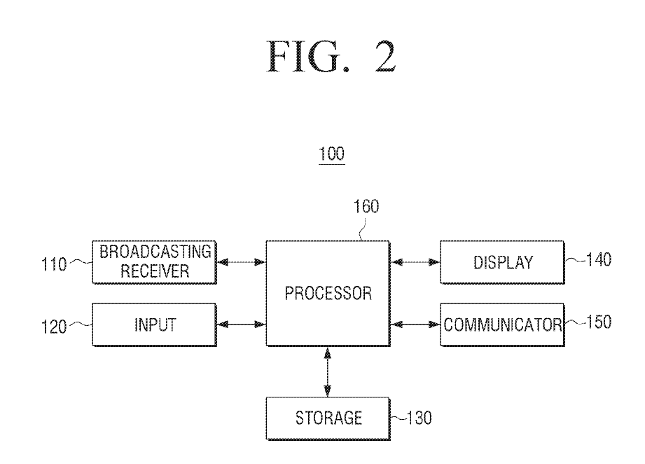

FIG. 2 is a block diagram illustrating a configuration of the broadcast receiving device according to an exemplary embodiment.

Referring to FIG. 2, the broadcast receiving device 100 includes a broadcast receiver 110, an input 120, a storage 130 (e.g., memory), a display 140, a communicator 150, and a processor 160.

The broadcast receiving device 100 may be a digital TV but exemplary embodiments are not limited thereto. The broadcast receiving device 100 may be implemented as various electronic devices such as a portable phone, a tablet PC, a notebook PC, a PDA, and a DVD player including the display 140, or a set top box connected to a separate display device without the display. Below, for convenience of explanation, the broadcast receiving device 100 will be described as a digital TV.

The broadcast receiver 110 may receive a digital broadcasting signal from a broadcasting station or a satellite in a wired manner or a wireless manner. The broadcast receiver 110 may receive various kinds of broadcasting signals transmitted from the broadcasting station through a radio frequency network (RF network) and may receive broadcasting through an IP network from various kinds of servers. In this case, the RF network is a communication network which radiates a radio frequency to exchange information. Thus, a wideband is expanded and a link of additional services is possible. An Internet protocol network (IP network) is a network of protocol to exchange a packet between several independent networks, as a rule, to connect communication networks independently operated on the Internet.

A detailed configuration of the broadcast receiver 110 and a receiving method by the broadcast receiver 110 may be variously implemented according to an exemplary embodiment.

The broadcast receiver 110 may receive EPG information including information about a plurality of broadcasting programs. Program information, e.g., information associated with the broadcasting program, is called EPG information. For example, an electronic program guide (EPG) may include information associated with a program such as a program title, a program type, a program date, program classification, playing time of a program, characters of a program, a director of a program, a writer of a program, awards that a program has won, actors of a program, etc. Further, the program information may include information corresponding to a program such as a program title, a program broadcasting period, a program broadcasting day, program broadcasting time, a program type, program classification, a director and characters of a program, and a program plot.

The input 120 inputs a user command to the broadcast receiving device 100. The input 120 may input user commands controlling the broadcast receiving device 100. When the display 140 (described below) includes a touch pad, the input 120 may be included in the touch pad of the display 140 and may be implemented as a remote controller, a portable phone, and a mouse, etc. When the input 120 is implemented as a remote controller, a portable phone, or a wireless mouse, the broadcast receiving device 100 may remotely receive the user command. When the input 120 is implemented as a wired mouse, the broadcast receiving device 100 may be physically connected to the mouse to receive the user command.

The input 120 may receive the user command for selecting the wanted channel from the list of other channels displayed. For example, when sensing that the advertisement image starts while the user watches a program image, the broadcast receiving device 100 may display a list of other channels associated with the channel that the user is watching on the display 140. In this case, if the list of other channels associated with the channel that the user is watching is displayed, the input 120 may receive the user command for selecting one channel from the list of other channels displayed.

When sensing that the advertisement image starts while the user watches the program image, the input 120 may receive a user's preference channel information for generating the list of other channels displayed.

In this case, the list of other channels associated with the channel that the user is watching may be generated using a plurality of channel information pre-classified according to the program type that is broadcast on the channel or a plurality of preference channel information previously input through the input 120 (described below) by the user.

In this case, the list of other channels may be generated using the plurality of channel information on which a program having a type similar to that of the channel that the user is watching among the plurality of channel information pre-classified is broadcast. In this case, the plurality of channels on which the program having the type similar to that of the channel that the user is watching may be a plurality of channels having the same frequency as the channel that the user is watching. The broadcasting provider transmits the plurality of channels within the same frequency together for transmission efficiency. The channels having the same frequency are highly likely to be the channels associated with each other to be appropriate to generate the list of other channels.

For convenience of explanation, the types of programs broadcast described above are sports broadcasts. However, the types of programs may be various content types such as drama, music, movie, and home shopping.

For convenience of description, it is described above that the list of other channels associated with the channel that the user is watching is in a table form, however, the list of other channels may be implemented in many different forms. For example, the list may be implemented as a thumbnail form and a form in which the images of the plurality of channels associated are displayed in a picture in picture (PIP) scheme.

The storage 130 (e.g., memory) stores various programs and data for driving the broadcast receiving device. For example, the storage 130 may store an operating system (OS) for driving the broadcast receiving device 100, an application for performing various functions, data used while the application is executed, etc. In addition, the storage 130 may store various software modules such as a base module, a sensing module, a communication module, a presentation module, a web browser module, and a service module.

The storage 130 may store the plurality of channel information. In detail, the storage 130 may store the plurality of channel information for generating the list of other channels associated with the channel that the user is watching. In this case, the storage 130 may store the plurality of channel information classified according to the types of broadcasting programs. The plurality of channel information classified according to the types of broadcasting programs may be one previously input in a manufacturing step of the broadcast receiving device 100, one classified by the EPG information received through the broadcast receiver 110, or one received by the communicator 150 (described below) connected to an external server. Further, the storage 130 may store the plurality of preference channel information input through the input 120 by the user.

The display 140 may display images obtained by decoding the digital broadcasting signal received by the broadcast receiver 110. In detail, the display 140 may display the broadcasting program image and the advertisement image. Further, if the start of the advertisement image after the program image is sensed, the display 140 may display the list of other channels associated with the channel that the user is watching. In this case, the display 140 may display the list of other channels along with the advertisement image and may also display only the list of other channels. In this case, the display 140 may display the list of other channels on a main screen and may also display the list of other channels on a sub-screen, which is some area of the main screen in a PIP scheme.

The PIP may be a small image additionally overlaying the present image. By using this, the user may watch various additional information of the present image, the list of other channels, an image of a channel selected from the list of other channels and a size and a position of the sub-screen may be adjusted.

If the user selects one channel from the list of other channels displayed, the display 140 may display the image of the selected channel. In this case, the display 140 may change the image of the main screen to the image of the selected channel and display the image of the selected channel or may display the image of the selected channel on the sub-screen which is some area of the main screen in the PIP scheme.

For convenience of explanation, it is described above that the broadcast receiving device 100 includes the display 140, but the broadcast receiving device 100 may also be implemented in a state in which it is connected to a separate display device without the broadcast receiving device 100 itself, such as a set top box including the display.

The communicator 150 connects the broadcast receiving device 100 to the external device, and may be implemented in a form in which it is connected to the external device through a universal serial bus (USB) as well as a form in which it is connected to the external device through a local area network (LAN) and the Internet network. In detail, the communicator 150 may receive the plurality of channel information for generating the list of other channels from the external device such as a server. In this case, the channel information received may be the channel information classified for each broadcasting program type.

The processor 160 controls a general operation of the broadcast receiving device 100. In detail, the processor 160 may control the display 140 to display the images obtained by decoding the digital broadcasting signal received by the broadcast receiver 110. In this case, the image may include the broadcasting program image and the advertisement image.

If the start of the advertisement image after the program image is sensed, the processor 160 may perform a control to display the list of other channels associated with the channel that the user is watching. In this case, the processor 140 may perform a control to display the list of other channels along with the advertisement image or display only the list of other channels. The processor 160 may perform a control to display the list of other channels on the main screen or display the list of other channels on a sub-screen that is some area of the main screen in the PIP scheme. In this case, the processor 160 may perform a control to display the sub-screen while changing the size and position of the sub-screen according to the user command.

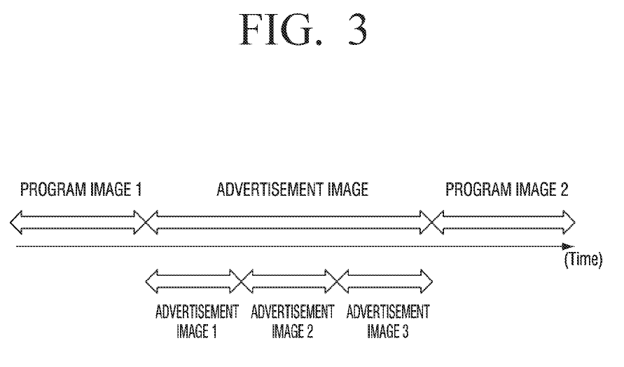

The processor 160 may sense the start of the advertisement image using program and system information protocol (PSIP) information included in the digital broadcasting signal received through the broadcast receiver 110. The PSIP is a standard made for describing programs and data transmitted from a digital TV and various information for TV reception. Here, an example of the standard may include ATSC standard 65. The PSIP is a set of tables devised to be operated within all transmission streams for the digital TV and provides information for reception by describing information of a virtual channel transmitted from a specific transmission stream. A method for sensing the start of the advertisement image using the PSIP information will be described in detail with reference to FIGS. 3 to 5.

If the user selects one channel from the list of other channels displayed, the processor 160 may display the image of the selected channel. In this case, the display 140 may change the image of the main screen to the image of the selected channel and display the image of the selected channel or may display the image of the selected channel on the sub-screen which is some area of the main screen in the PIP scheme.

If the start of the advertisement image after the program image is sensed, the processor 160 may perform a control to change the advertisement image to an image of any channel among other channels associated with the channel that the user is watching and display the image of any channel and display the list of other channels in the changed image. If the user selects one channel from the list of other channels displayed, the processor 160 may perform a control to display the image of the selected channel. In this case, the processor 160 may perform a control to change the image of the main screen to the image of the selected channel and display the image of the selected channel or may display the image of the selected channel on the sub-screen which is some area of the main screen in the PIP scheme.

Any channel among the other channels may be a channel having the lowest channel number among other channels associated with the channel watched by the user or may be a channel having the channel number closest to a channel number watched by the user.

The processor 160 may perform a control to display the list of other channels by sensing the start of the advertisement image after the program image and then display the advertisement image from which the list of other channels displayed is removed if the user command is not input for a predetermined time.

FIG. 3 is a diagram schematically illustrating an example of advertisement image start information inserted while a user watches a broadcasting program.

Referring to FIG. 3, the broadcast receiving device according to an exemplary embodiment may display the advertisement image after program image 1. For example, if all three advertisement images are displayed, the broadcast receiving device may display program image 2 later. The program image 1 and the program image 2 may be the same broadcasting program and may also be another broadcasting program. The provided broadcasting image may be an advertisement image which is provided by a key station (e.g., national station) or a local station. In the digital broadcasting system, the number of advertisements inserted while a user watches the broadcasting program, insertion timing of advertisement, etc., are defined as an agreement and one illustrated in FIG. 3 is only an example of the agreement. Therefore, upon the actual implementation, the number of advertisements, the insertion timing of advertisement, whether the advertisement image is provided by the key station or the local station, etc., may be changed according to the agreement.

The broadcast receiving device according to an exemplary embodiment may sense the start of the advertisement image using the PSIP information included in the digital broadcasting signal received through the broadcast receiver. Below, FIGS. 4 and 5 illustrate tables showing an example of the PSIP information for sensing the start of the advertisement image inserted while the user watches the broadcasting program.

FIG. 4 is a diagram illustrating a segmentation descriptor for sensing the start of the advertisement image inserted while the user watches the broadcasting program, according to an exemplary embodiment.

A syntax illustrated in FIG. 4 is shown as an appropriate example of understanding a flow of broadcasting in an exemplary embodiment of the digital broadcasting. Referring to FIG. 4, the broadcasting program, the number of advertisements, and the broadcasting time of an image, etc., may be understood. In detail, a segmentation_upid_type may be a type of the broadcasting program, a segmentation_upid_length may be a length of the broadcasting program, and a segmentation_type_id may specify an event number. The content of the event number will be described below in detail with reference to FIG. 5.

FIG. 5 is a diagram illustrating an example of an agreement indicating the event number.

Referring to FIG. 5, a program start and a program end, a program early termination, program resumption, a provider advertisement start and a provider advertisement end, a distributor advertisement start and a distributor advertisement end, etc., are shown as a table of the event number. The broadcast receiving device may sense a generation of each event on the basis of the event number.

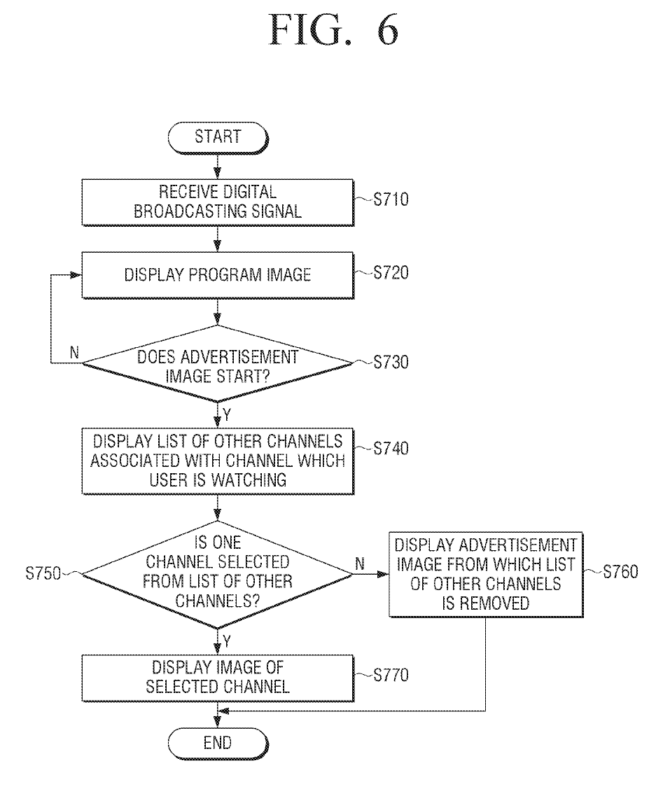

FIG. 6 is a flow chart for describing a method for changing a channel according to an exemplary embodiment.

Referring to FIG. 6, first, the broadcast receiving device receives the digital broadcasting signal (S710). In this case, the digital broadcasting signal is received from a broadcasting station or a satellite in a wired manner or a wireless manner and the digital broadcasting signal includes the signals for the program image and the advertisement image. Next, the broadcast receiving device displays the images obtained by decoding the received digital broadcasting signal. The broadcast receiving device displays the program image (S720). Next, it is sensed whether the advertisement image starts while the user watches the program image displayed (S730). When the start of the advertisement image is not sensed (S730-N), the broadcast receiving device continuously displays the program image that the user is watching. When the start of the advertisement image is sensed (S730-Y), the broadcast receiving device displays the list of other channels associated with the channel that the user is currently watching (S740). In this case, the broadcast receiving device may display the list of other channels on the main screen or display the list of other channels on the sub-screen which is some area of the main screen in the PIP scheme. When the start of the advertisement image is sensed, the broadcast receiving device determines whether the preference channel is stored to display the list of the preference channels if the stored preference channels are present and display the list of other channels associated with the channel that the user is watching if the stored preference channels are not present. In this case, the list of other channels associated with the channel that the user is watching may include a plurality of channels having a type similar to that of the channel that the user is currently watching.

Next, the broadcast receiving device determines whether the user selects one channel from the list of other channels displayed (S750). If the user selects one channel from the list of other channels (S750-Y), the broadcast receiving device may display the image of the selected channel (S770). In detail, if the user selects one channel from the list of other channels using the input such as a remote controller, a touch screen, and a mouse, the broadcast receiving device may display the image of the selected channel. The broadcast receiving device may display the image of the selected channel on the main screen or display the image of the selected channel on the sub-screen which is some area of the main screen in the PIP scheme. If the user does not select one channel from the list of other channels while a predetermined time elapses (S750-N), the broadcast receiving device may continuously display the advertisement image from which the list of other channels is removed (S760).

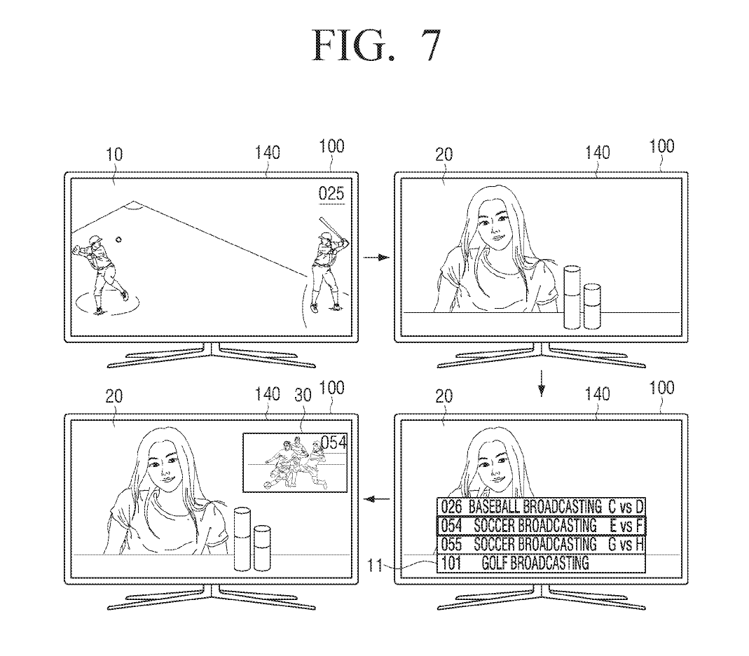

FIGS. 7 to 9 are diagrams for describing an operation of a broadcast receiving device according to one or more exemplary embodiments.

FIG. 7 illustrates an example of the operation of the broadcast receiving device, and when the advertisement image 20 (e.g., cosmetics advertisement) starts at the intermission time while the user watches the baseball broadcasting 10 (e.g., A team vs B team) broadcast on the channel [025], the broadcast receiving device 10 may sense the start of the advertisement image 20 to display the advertisement image 20 and the list 11 of other channels associated with the baseball broadcasting channel [025] that the user is watching together. In this case, the list 11 of other channels may be the sport channel list. In detail, the list 11 of other channels may include the channel [026] on which the baseball game of another team is broadcast (e.g., C team vs D team), the channels [054] and [055] on which the soccer game is broadcast, the channel [101] on which the golf game is broadcast, etc.

In this case, when the user selects the channel [054] on which the soccer game is broadcast from the list 11 of other channels displayed along with the advertisement image 20, the broadcast receiving device 100 may display the image of the channel [054] broadcasting the soccer game on the sub-screen which is some area of the main screen on which the advertisement image 20 is displayed in the PIP scheme.

When the user wants, such as when the user selects the sub-screen using the input, the image of the main screen and the image of the sub-screen may be switched.

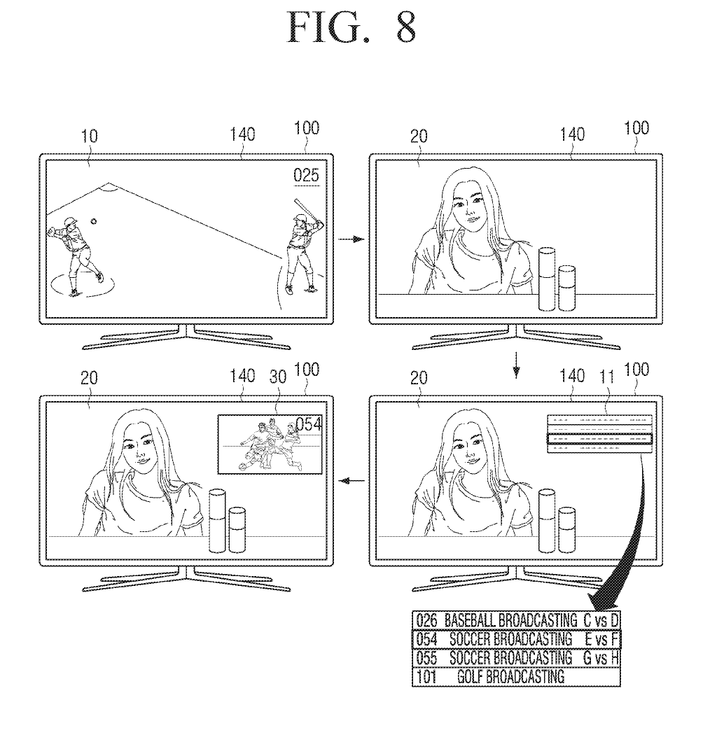

FIG. 8 illustrates another example of the operation of the broadcast receiving device, and when the advertisement image 20 (e.g., cosmetics advertisement) starts at the intermission time while the user watches the baseball broadcasting 10 (e.g., A team vs B team) broadcast on the channel [025], the broadcast receiving device 100 may sense the start of the advertisement image 20 to display the list 11 of other channels associated with the baseball broadcasting channel [025] that the user is watching on the sub-screen, which is some area of the main screen on which the advertisement image 20 is displayed. In this case, the list 11 of other channels may be the sport channel list. In detail, the list 11 of other channels may include the channel [026] on which the baseball game of another team is broadcast (for example, C team vs D team), the channels [054] and [055] on which the soccer game is broadcast, the channel [101] on which the golf game is broadcast, etc.

When the user selects the channel [054] on which the soccer game is broadcast from the list 11 of other channels displayed on the sub-screen, the broadcast receiving device 100 may display the image 30 of the channel [054] broadcasting the soccer game on the sub-screen, which is some area of the main screen on which the advertisement image 20 is displayed in the PIP scheme. When the user selects one channel from the list 11 of other channels displayed on the sub-screen, the broadcast receiving device 100 may display the image of the selected channel on the main screen and may also display the advertisement image on the sub-screen.

When the user wants, i.e., when the user selects the sub-screen using the input, the image of the main screen and the image of the sub-screen may be switched.

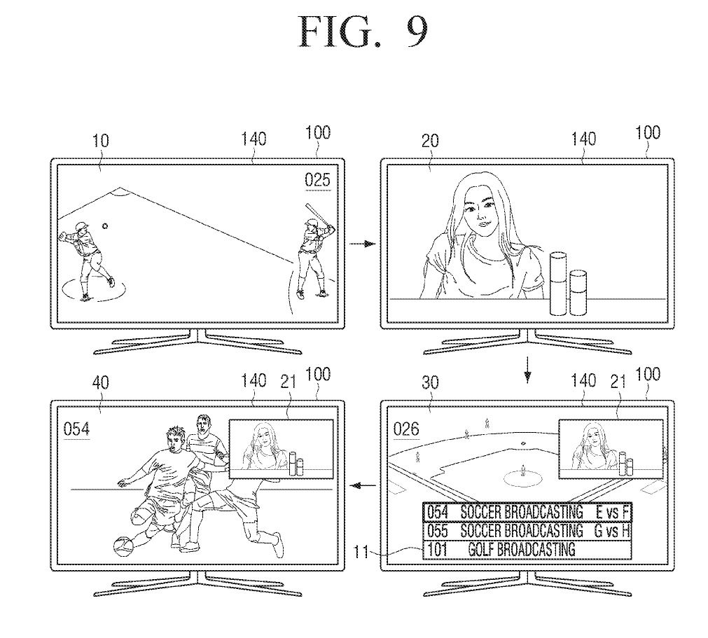

FIG. 9 illustrates another example of the operation of the broadcast receiving device, and when the advertisement image 20 (for example, cosmetics advertisement) starts at the intermission time while the user watches the baseball broadcasting 10 (for example, A team vs B team) broadcast on the channel [025], if the start of the advertisement image 20 is sensed, the broadcast receiving device 100 may change the advertisement image 20 to the image 30 of any channel (for example, [026]) among other channels associated with the channel [025] on that the user is watching and display the image 30 of any channel.

In detail, the broadcast receiving device 100 may automatically change the advertisement image to the image of the channel [026] (e.g., C team vs D team) broadcasting another baseball game having the lowest channel number or the closest channel number among the channels associated with the channel [025] on which the advertisement image is watched and display the image of the channel [026]. In this case, the broadcast receiving device 100 may display the advertisement image 21 in the changed image in the PIP scheme. In this case, the broadcast receiving device 100 may display the list of other channels associated with the channel that the user is watching.

According to an exemplary embodiment, the broadcast receiving device 100 may display the list 11 of other channels associated with the baseball broadcasting channels

and [026] in a PIP scheme, and display the advertisement image 21 on the sub-screen which is some area of the main screen on which the changed image 30 is displayed. In this case, the list 11 of other channels may be the sport channel list. In detail, the list 11 of other channels may include the channels [054] and [055] on which the soccer game is broadcast and the channel [101] on which the golf game is broadcast, etc.

In this case, when the user selects a channel [054] on which the soccer game is broadcast from the list 11 of other channels displayed, the broadcast receiving device 100 may change the changed image 30 to an image 40 of the channel [054] on which the soccer game is broadcast and display the image 40. In this case, the broadcast receiving device 100 may display the advertisement image 21 in the image 40 of the channel [054] on which the soccer game is broadcast in the PIP scheme.

When the user wants, i.e., when the user selects the sub-screen using the input, the image of the main screen and the image of the sub-screen may be switched.

As described above, according to one or more exemplary embodiments, if the advertisement broadcasting starts while the user watches the digital broadcasting, the user may minimize time consumed to change many channels one by one, or to confirm broadcasting contents on other channels by displaying the received EPG information. Further, it is possible to provide user customized advertisement by confirming preference advertisement depending on the user's channel selection.

The methods according to one or more exemplary embodiments may be implemented as a program command type that may be performed through various computer units and may be recorded in a computer readable medium. The computer-readable medium may include a program command, a data file, a data structure or the like, alone or a combination thereof. For example, the computer-readable medium may be stored in a volatile or non-volatile storage device such as a ROM, a memory such as a RAM, a memory chip, and a device or an integrated circuit, or a storage medium which may be read with a machine (e.g., computer processing unit (CPU)) simultaneously with being optically or magnetically recorded like a CD, a DVD, a magnetic disk, a magnetic tape, or the like, regardless of whether it is deleted or again recorded. The memory, which may be included in a mobile terminal, may be one example of a storage medium which may be read with programs including instructions implementing the exemplary embodiments or a machine appropriate to store the programs. The program commands recorded in the computer-readable medium may be designed for the exemplary embodiments or be known to those skilled in a field of computer software.

Although exemplary embodiments have been disclosed for illustrative purposes, those skilled in the art will appreciate that various modifications, additions and substitutions are possible, without departing from the scope and spirit of the invention as disclosed in the accompanying claims.

Accordingly, the scope of the present invention is not construed as being limited to the described exemplary embodiments, but is defined by the appended claims as well as equivalents thereto.

What is claimed is:

1. A broadcast receiving device, comprising:
a broadcast receiver configured to receive a digital broadcasting signal;
a display configured to display images that are obtained by decoding the received digital broadcasting signal; and
a processor configured to, in response to sensing a start of an advertisement image, control the display to display a list of other channels associated with a program channel, and in response to a user selecting a channel from among the other channels, display an image of the selected channel.

2. The broadcast receiving device of claim 1, wherein the processor is further configured to sense the start of the advertisement image using program and system information protocol (PSIP) information included in the received digital broadcasting signal.

3. The broadcast receiving device of claim 1, further comprising:
a memory configured to store at least one among channel information classified according to a program type and preference information previously input by the user.

4. The broadcast receiving device of claim 3, wherein the list of other channels associated with the program channel is generated by using at least one among the channel information indicating a program having a type that is similar to the program channel and the preference information stored in the memory, and
wherein the channel information indicating the program having the type similar to the program is determined according to a frequency of the channels.

5. The broadcast receiving device of claim 1, wherein the processor is further configured to, in response to sensing the start of the advertisement image, display the list of other channels associated with the program channel along with the advertisement image.

6. The broadcast receiving device of claim 1, wherein the processor is further configured to, in response to sensing the start of the advertisement image, display the list of other channels associated with the program channel in the advertisement image in a picture in picture (PIP) scheme.

7. The broadcast receiving device of claim 6, wherein the processor is further configured to display the image of the selected channel in the advertisement image in the PIP scheme in response to the user selecting one channel from the list of other channels associated with the program channel.

8. The broadcast receiving device of claim 1, wherein the processor is further configured to, in response to the user selecting one channel from the list of other channels, change the advertisement image to the image of the selected channel and display the advertisement image in a PIP scheme.

9. The broadcast receiving device of claim 1, wherein the processor is further configured to, in response to the start of the advertisement image being sensed, change the advertisement image to an image of another channel among the other channels that is associated with the program channel, display the list of other channels associated with the program channel in the changed image, and in response to the user selecting one channel from the list of other channels, change the changed image to the image of the selected channel.

10. The broadcast receiving device of claim 9, wherein the another channel is one among a channel having a lowest channel number among the other channels associated with the program channel and a channel number that is closest to the program channel number.

11. The broadcast receiving device of claim 1, wherein the processor is further configured to, in response to the start of the advertisement image being sensed and the user not selecting a channel from the list of other channels for a predetermined time, display the list of other channels associated with the program channel.

12. A broadcast receiving device, comprising:
a broadcast receiver configured to receive a digital broadcasting signal; and
a processor configured to provide images that are obtained by decoding the received digital broadcasting signal to an external display device, and in response to sensing a start of an advertisement image, provide an image displaying a list of other channels associated with the program channel to the external display device, and in response to a user selecting one channel from among the list of other channels, change the advertisement image to an image of the selected channel.

13. A method for controlling a broadcast receiving device, the method comprising:
receiving a digital broadcasting signal;
displaying images obtained by decoding the received digital broadcasting signal;
in response to sensing a start of an advertisement image, displaying a list of other channels associated with a program channel; and
in response to a user selecting a channel from among the other channels, displaying an image the selected channel.

14. The method of claim 13, wherein the sensing the start of the advertisement image comprises using program and system information protocol (PSIP) information included in the received digital broadcasting signal.

15. The method of claim 13, further comprising:
storing at least one among channel information classified according to a program type and preference information previously input by the user,
wherein the list of other channels associated with the program channel is generated by using at least one of the channel information having a same frequency as the program channel and the channel information classified according to the program type.

16. The method of claim 13, wherein the displaying the list of other channels associated with the program channel comprises, in response to sensing the start of the advertisement image, displaying the list of other channels associated with the program channel in a picture in picture (PIP) scheme.

17. The method of claim 16, wherein the displaying the image of the selected channel comprises, in response to the user selecting one channel from the list of other channels, displaying the image of the selected channel in the PIP scheme.

18. The method of claim 13, wherein the displaying the image of the selected channel comprises, in response to the user selecting one channel from the list of other channels, changing the advertisement image to the image of the selected channel and displaying the changed image in the picture in picture (PIP) scheme.

19. The method of claim 13, further comprising:
in response to the start of the advertisement image being sensed, changing the advertisement image to an image of another channel among the other channels associated with the program channel,
wherein the displaying of the image of the selected channel comprises, in response to the user selecting one channel from the list of other channels, changing the changed image to the image of the selected channel.
